(19) United States
(12) Patent Application Publication
(10) Pub. No.: US 2002/0199120 A1
(43) Pub. Date: Dec. 26, 2002

(54) Monitored network security bridge system and method

(76) Inventor: Jeffrey A. Schmidt, Hilliard, OH (US)

Correspondence Address: FAY, SHARPE, FAGAN, MINNICH & McKEE, LLP, Seventh Floor, 1100 Superior Avenue, Cleveland, OH, 44114-2518, US

(21) Appl. No.: 10/139,855

(22) Filed: May 6, 2002

Related U.S. Application Data
(60) Provisional application No. 60/289,001, filed on May 4, 2001.

(51) Int. Cl. G06F 11/30; G06F 15/173

(52) U.S. Cl. 713/201; 709/224

(57) ABSTRACT

A bridge device is located between a user's internal network and an external network such as the internet or other public global computer network. Incoming and/or outgoing network data traffic streams are received into the bridge and processed in the bridge in an effort to prevent malicious or potentially malicious data traffic from reaching the internal network from the external network and/or to prevent malicious or potentially malicious data traffic from reaching the external network from the internal network. The bridge communicates with and is controllable from a remote data center by way of an out-of-band channel such as a dial-up connection or the like. The bridge is configured to contact the remote data center through the out-of-band channel when suspicious and/or potentially malicious activity is detected in the incoming and/or outgoing data streams. The bridge tracks and controls internet usage and other incoming and outgoing network traffic and is also used to inhibit flow of virus-infected e-mails to an internal mail server and/or to create safer substitute e-mails that replace potentially malicious e-mails.

### CROSS-REFERENCE TO RELATED APPLICATION

This application claims the benefit of and priority from U.S. provisional application No. 60/289,001 filed May 4, 2001, which application is hereby expressly incorporated by reference.

### BACKGROUND OF THE INVENTION

The present development relates generally to computer network security and, more particularly, to a method and apparatus for providing monitored network security by way of a bridge system located between a user's internal network and an external network such as the internet or other public global computer network.

Heretofore, computer network operators have relied upon firewalls to inhibit attacks on an internal network by hackers or others unauthorized users. Also, it is well known to use virus scanning software located on an mail server and/or on client machines of a computer network for purposes of attempting to locate and eradicate any virus connected to or associated with incoming e-mails and/or other incoming network data traffic. A deficiency with prior firewall arrangements is that they are passive devices in the sense the once installed, they are not actively monitored and controlled on a regular basis. Thus, a computer network operator may be completely unaware, at least for some period of time, that hackers or other unauthorized users are seeking to infiltrate or have already successfully infiltrated its network. With respect to prior e-mail virus scanning systems, these virus scanning operations take place on the computer network operator's internal mail server and, obviously, this is undesirable in that any potential virus has already infiltrated the computer network operator's internal computer network. Also such solutions require that the customer operate in internal mail server, and are costly and complex to install and maintain.

In light of the foregoing, a need has been found for a monitored network security bridge system that overcomes the foregoing deficiencies and others while providing better overall results.

### SUMMARY OF THE INVENTION

In accordance with the present invention, a method for enhancing network security includes locating a bridge operatively between a public computer network and a private computer network and receiving incoming network data traffic from the public computer network into the bridge prior to the incoming network data traffic being transmitted to the private computer network. The incoming network data traffic is analyzed in the bridge to determine if it includes potentially malicious network data traffic. A non-public communications channel is used to connect the bridge to a remote data center and to send data from the bridge to the remote data center in order to notify the data center that potentially malicious incoming network data traffic has been received by the bridge when the bridge determines that the incoming network data traffic includes potentially malicious incoming network data traffic. The bridge is controlled from the data center through said non-public communications channel to respond to the potentially malicious network data traffic to limit passage of further potentially malicious incoming network data traffic to the private computer network.

In accordance with another aspect of the present invention, a method for monitoring and controlling e-mail includes receiving an original e-mail message intended for a downstream recipient and determining if the original e-mail includes a potentially dangerous attachment. A safer substitute e-mail comprising a header and a body is created to replace the original e-mail when the original e-mail is deemed to include a potentially dangerous attachment. The substitute e-mail is sent to the intended downstream recipient in place of said original e-mail.

### BRIEF DESCRIPTION OF THE DRAWINGS

The invention comprises various components and arrangements of components and various steps and arrangements of steps, preferred embodiments of which are illustrated in the accompanying drawings that form a part hereof and wherein:

FIG. 1 is a diagrammatic illustration of a monitored network security bridge system and method in accordance with the present invention;

FIG. 2 is a high-level flow chart that illustrates a monitored network security bridge method in accordance with the present invention;

FIGS. 3A and 3B (referred to herein together as FIG. 3) define a flow chart that illustrates network activity control and monitoring process in accordance with the present invention;

FIGS. 4A and 4B (referred to herein together as FIG. 4) define a flow chart that illustrates a MIME-type e-mail monitoring process in accordance with the present invention;

FIG. 5 is a flow chart that illustrates a process for creating a substitute e-mail as a sub-step of the MIME-type e-mail monitoring process;

FIG. 6 is a flow chart that illustrates a header-type e-mail monitoring process in accordance with the present invention; and

FIG. 7 is a flow chart that illustrates a virus scan e-mail monitoring process in accordance with the present invention.

### DETAILED DESCRIPTION OF PREFERRED EMBODIMENTS

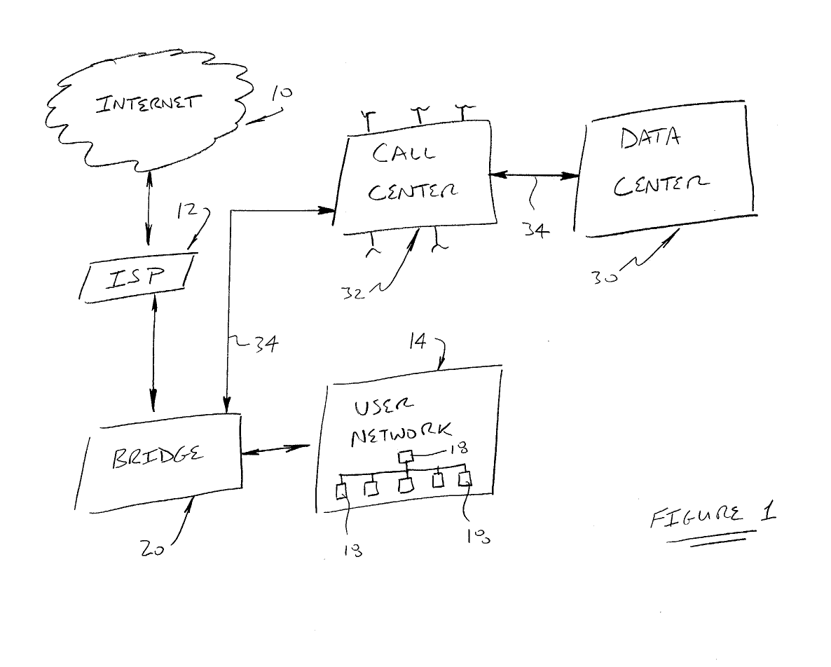

Referring now to the drawings, FIG. 1 diagrammatically illustrates a monitored network security bridge system and method in accordance with the present invention. More particularly, FIG. 1 illustrates the internet or other public computer network 10 and an internet service provider (ISP) 12 that provides a connection by which a user network 14 is able to access the internet. The user network comprises one or more network servers and client computer devices 18 interconnected with each other by a private internal network such as an Ethernet network or other suitable network system.

To provide a monitored network security bridge system and method in accordance with the present invention, a bridge 20 is located downstream from the ISP 12 but upstream from all aspects of the user network 14, i.e., all network data traffic that flows between the user network 14 and the ISP 12 must pass through the bridge 20. The bridge 20, itself, is preferably provided in the form of a computer such as a personal computer running an operating system such as UNIX, LINUX or any of the operating systems available commercially from Microsoft Corporation and sold under the WINDOWS® family of operating systems, i.e., WINDOWS® NT. In one suitable implementation, the bridge 20 is provided by a personal computer running an Open BSD UNIX operating system. The bridge may contain: at least two network interfaces which may be any combination of Ethernet, DS(T) circuits, token-ring, etc; random access memory (RAM); some form of persistent memory such as FLASH or battery-baked RAM; and fixed-disks. Multiple network interfaces provide the ability to participate in a diverse set of network topologies and also provide multiple physical and logical de-militarized-zones (DMZs) with a single network appliance.

The bridge 20 is operatively connected to the ISP 12 by way of a DSL, T-1 or any other suitable wired or wireless network connection. Similarly, the bridge 20 is operatively connected to the user network 14 by way of an Ethernet or other network interface using a suitable wired or wireless connections such as RJ-45, USB, coaxial cable, optical fiber, etc.

The bridge 20 is programmed to act as a software firewall to prevent unauthorized network traffic between the ISP 12 and the user network 14. Hardware and software firewalls, in general, are well known to those of ordinary skill in the art. In general, such a firewall prevents or at least inhibits the flow of unauthorized network traffic from the ISP 12 to the user network 14, while allowing other network traffic. Thus, for example, a hardware or software firewall can be configured to allow network traffic to flow from the ISP 12 to a mail server of the user network 14 while preventing network traffic from the ISP 12 to a file server of the user network 14 that contains confidential client files.

The bridge 20 also includes a means for selectively communicating with a remote data center 30 that includes one or more people and/or computers that interact with and can control the bridge. In a preferred embodiment, the selective communication means can comprise a modem that selectively communicates to the data center 30 through a call center 32. While it is most preferred, from a business standpoint, that the call center 32 be separate from the data center 30, the call center 32 can be part of the data center 30 without departing from the overall scope and intent of the present invention. It is most preferred, as described in full detail below, that the modem or other communication device of the bridge 20 be configured to dial or otherwise connect to the call center 32 only, i.e., it is preferred that the modem not accept incoming telephone calls and not be configured to call any number other than one or more known telephone numbers that connect the modem to the call center 32.

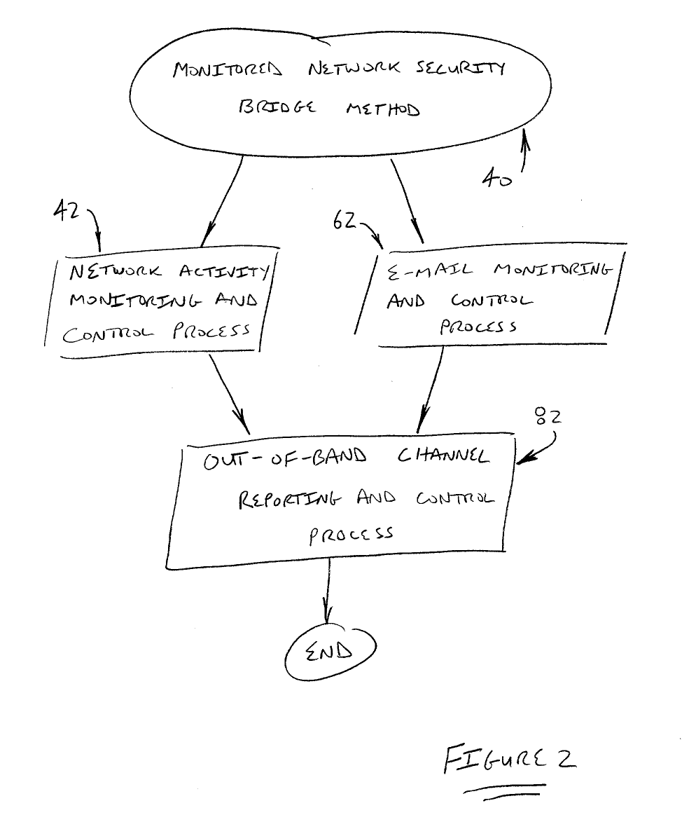

Referring now to FIG. 2, a monitored network security bridge method in accordance with the present invention is disclosed. The monitored network security bridge method 40 comprises a network activity monitoring and control process 42 and an e-mail monitoring and control process 62, the details of which are set forth below. The monitored network security bridge method further comprises an out-of-band reporting/control process 82 which is also described below.

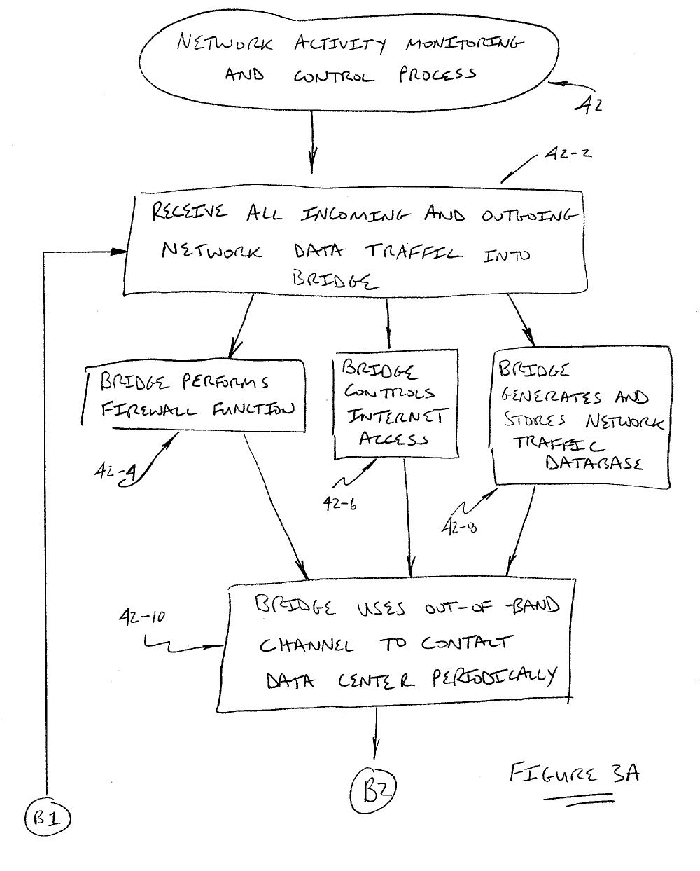

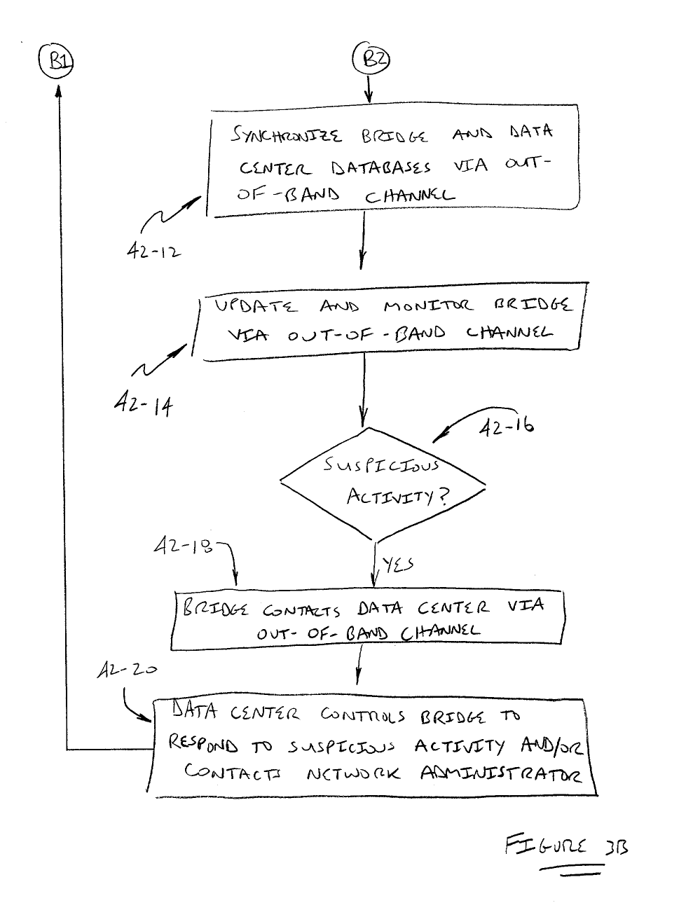

Turning now to FIG. 3 (FIGS. 3A and 3B), a preferred embodiment of the network activity monitoring/control process 42 is disclosed. The process 42 comprises a step 42-2 of receiving all incoming/outgoing data into bridge the bridge 20. As noted above, this is carried out by connecting the bridge operatively between the ISP 12 and the user network 14 whereby all network data traffic flowing between the ISP and the user network 14 must first pass through the bridge 20. This, then, allows the bridge 20 to be used to control the flow of this network traffic before the network traffic is pass through the bridge.

In particular, in a step 42-4, the bridge 20 performs a firewall function whereby the bridge blocks access to the user network 18 for unauthorized network data traffic in the same manner that is well known in connection with conventional hardware and software firewalls. As such, the bridge 20 provides a traditional firewall function via step 42-4.

In a step 42-6, the bridge 20 also controls internet access according to select parameters that are changeable as desired by the administrator of the user network 14. In the step 42-6, for example, the bridge is programmed to allow internet access only during certain hours of the day and/or only for filtering and blocking access by user of the network 14 to certain internet web site addresses, newsgroups and/or other network locations.

In a step 42-8, the bridge 20 generates and stores a database of all address of all incoming and outgoing network traffic. In this step 42-8, the bridge records all incoming e-mail address, outgoing e-mail addresses, all websites accessed by users of the network 14. The bridge also records time of day and time usage associated with the foregoing activities. The database of all address information generated and stored in the step 42-8 provides a forensic quality record of the origin and destination of all network data traffic flowing into and out of the user network 14.

In a step 42-10, the bridge 20 uses an out-of-band channel 34 (FIG. 1) to contact the data center 30 on a periodic basis, e.g., every 3 hours. An out-of-band channel is defined herein to encompass any wired and/or wireless connection between the bridge 20 and the data center 30 that does not include the user network 14, the ISP 12 and/or the internet 10. Thus, in one example, the out-of-band channel comprises a private telephone dial-up connection between the modem of the bridge 20 and the data center 30 by way of the call center 32. Other examples of suitable out-of-band communication channels include peering arrangements with ISP's whereby the bridge would call into an ISP that would, in turn, provide a private connection to the data center 30, encrypted tunnel(s)/channel(s) through public networks such as the internet 10, secondary network connections, wireless protocols including cellular, AMPS, 802.11, GSM, CDMA, TDMA, Wide CDMA and the like.

Those of ordinary skill in the art will recognize that the out-of-band connection between the bridge 20 and the data center 30 provides a highly secure connection not accessible to unauthorized users that may have the ability to reach the bridge 20 through the internet 10 and the ISP 12.

In steps 42-12 and 42-14 the bridge 20 and the data center 30 synchronize so that the records of each are brought up-to-date. Thus, in the step 42-12, the database(s) generated by the bridge 20 in the step 42-10 are synchronized with corresponding databases stored at the data center 30 whereby the databases stored at the data center are updated to reflect all network traffic activity since the previous synchronization operation. Likewise, in the step 42-14, the bridge 20 is updated with software/firmware updates sent from the data center 30 to the bridge 20. Also, during the step 42-14, the computers and/or personnel operating the computers at the data center 30 monitor operation of the bridge 20 to ensure that the bridge is functioning properly.

Separate from and in addition to the above periodic out-of-band communication between the bridge 20 and the data center 30, in a step 42-16, the bridge 20, itself, according to select parameters, continuously determines if suspicious activity is present in or indicated by the network traffic it is receiving from the ISP 12 and/or the user network 14. Suspicious activity is defined to include any unauthorized or undesired activity by users of the network 14 with respect to sending data to and/or receiving data from the ISP 12 via bridge 20 or any unauthorized or undesired activity by user's of the network 14 with respect to the bridge 20, itself. Suspicious activity is also defined as any unauthorized or undesired access or attempted access to the bridge 20 and/or the network 14 by others via ISP 12. More generally, the bridge 20 is programmed so that any activity at the bridge 20 that is not desired or authorized by the administrator of the user network 14 is deemed suspicious activity. Of course, the exact nature of the suspicious activity will vary. Examples of suspicious activity include port scans, execution of attack scripts and the like originating from the internet 10 or ISP 12 and targeting a computer on the user network 14, execution of attack scripts originating on the user network 14 and targeting external computers, detection of unreasonable and/or abnormal volume of network traffic originating at the internet 10 or ISP 12 and targeting the user network 14 (e.g., a Distributed Denial of Service Attack), detection of unreasonable and/or abnormal volume of network traffic originating at the user network 14 and targeting others (e.g., if a computer on the user network has been caused to participate in a Distributed Denial of Service attack), detection of known attack signatures, and/or detection of known or potentially malicious traffic based upon actual code and/or header information, detection of known or potentially malicious traffic based upon statistical analysis and research of traffic. Suspicious activity can also include a user of the user network 14 attempting to access an inappropriate website or other data, physical or operative tampering with the bridge 20, and/or any physical or operative disconnection of the bridge 20 from the ISP 12 and/or the user network 14.

If suspicious activity is indicated according to the step 42-16, the bridge 20 is programmed to carry out a step 42-18 whereby the bridge 20 contacts the data center 30 automatically by an out-of-band channel 34, e.g., by using a modem to contact the data center 30 through the call center 32. In one embodiment, the step 42-18 also includes the bridge 20 and/or the data center 30 logging additional information concerning the suspicious activity. The step 42-18 can In a step 42-20, the data center personnel and/or computers respond to the suspicious activity as suspected and reported by the bridge 20. This can include setting the bridge to block any potentially harmful network data traffic or setting the bridge to block all network data traffic. The step 42-20 can also include contacting the network administrator of the user network 14 via person-to-person telephone call, an automatically generated telephone call, e-mail, page, etc. Following the step 42-20, the bridge returns to its normal state of operation such as at step 42-2 where the bridge resumes normal receipt of incoming and outgoing network data traffic.

It is very important to note that the bridge 20 is configured not to listen for incoming calls on the out-of-band channel 34. The bridge 20 is configured so that it will not receive telephone calls or other incoming connections on the out-of band channel 34 and, in this manner, unauthorized access to the bridge 20 by way of the out-of-band channel is prevented. Of course, the bridge 20 does receive in-band data from the ISP 12, i.e., the public can access the bridge by way of the ISP 12, but the bridge is configured so that it is controllable only through the out-of-band channel by computers and/or personnel at the data center 30. An authorized user (or an unauthorized user) can access the bridge 20 through an in-band connection from the ISP 12 for purposes of forcing the bridge to initiate an out-of-band connection with the data center 30. This does not represent a potential security breach because the bridge 20 is configured to connect only with the data center 30 (through the call center 32 or other authorized intermediaries) on the out-of-band channel 34 and such a connection provides no benefit to an unauthorized user.

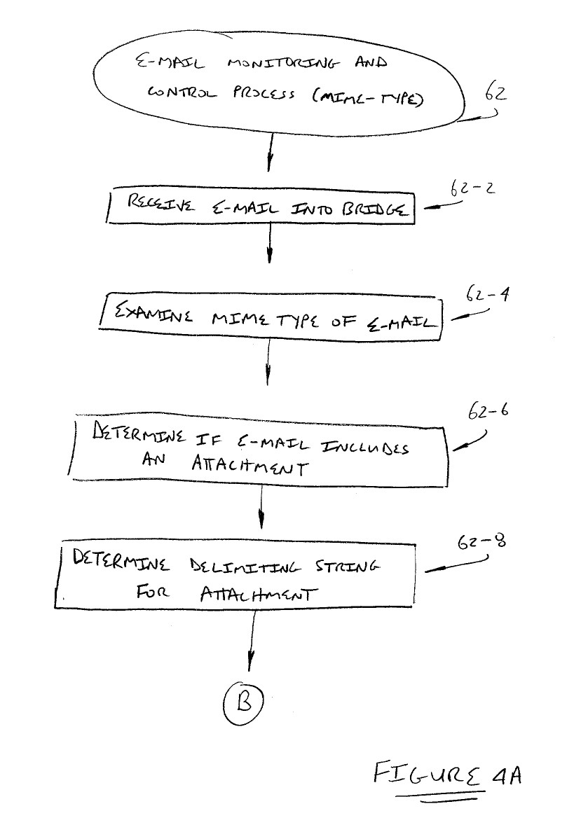

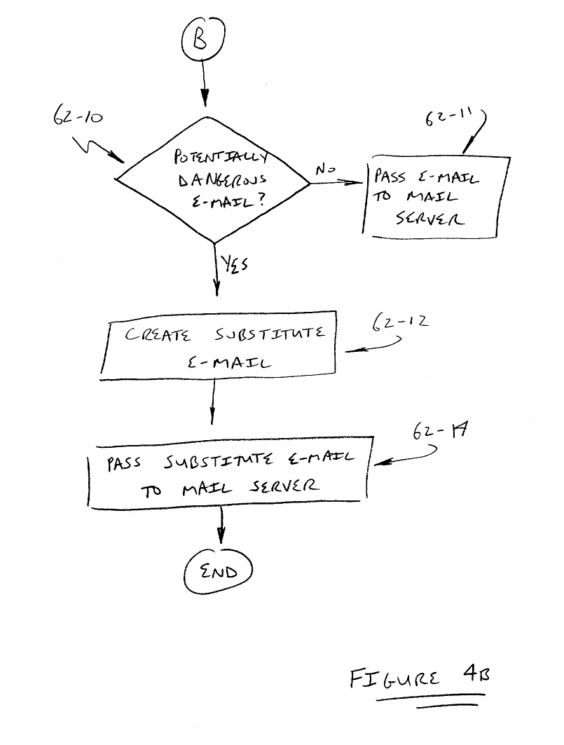

Referring now to FIGS. 4A and 4B, the bridge also receives all incoming e-mail from the ISP 12 and destined for a mail server on the user network. Therefore, before the incoming e-mail ever reaches the user network 14, the bridge is used to implement the e-mail monitoring/control process 62 to prevent any e-mail that include malicious content from reaching the user network and/or to alter any e-mails that include malicious content to prevent execution of the malicious content on the user network 14.

As shown in FIG. 4, in a step 62-2, the bridge 20 receives all incoming (and outgoing) e-mail. The bridge is programmed to identify and examine the MIME type of the e-mail in a step 62-4. A step 62-6 is carried out by the bridge whereby the bridge determines if the e-mail includes an attachment based upon the MIME type identified in step 62-4. A step 62-8 is carried out to determine the delimiting string for the attachment.

In a step 62-10, the bridge determines if the e-mail is potentially dangerous to the user network 14. This determination is made according to select rules that vary from installation to installation. For example, a network administrator can request that the bridge 20 be configured to find an e-mail to be potentially dangerous if it includes an attachment of any type that is executable, either by the operating system or by way of a third-party program. Examples of such attachments are those that include a “.exe” “.bat” “.pif” “.vbs” “.scr” file or other file extension that indicate that the attachment file includes some type of executable code. If the step 62-10 results in the bridge 20 determining that the e-mail is not potentially dangerous, the bridge is configured to pass the e-mail to the intended mail server on the user network 14 in a step 62-11 (while logging its origin and recipient in a database as noted above with respect to step 42-8). If, on the other hand, the step 62-10 determines that the e-mail is potentially dangerous, the bridge creates a safer, substitute e-mail in a step 62-12 and passes the substitute e-mail to the mail server in a step 62-14.

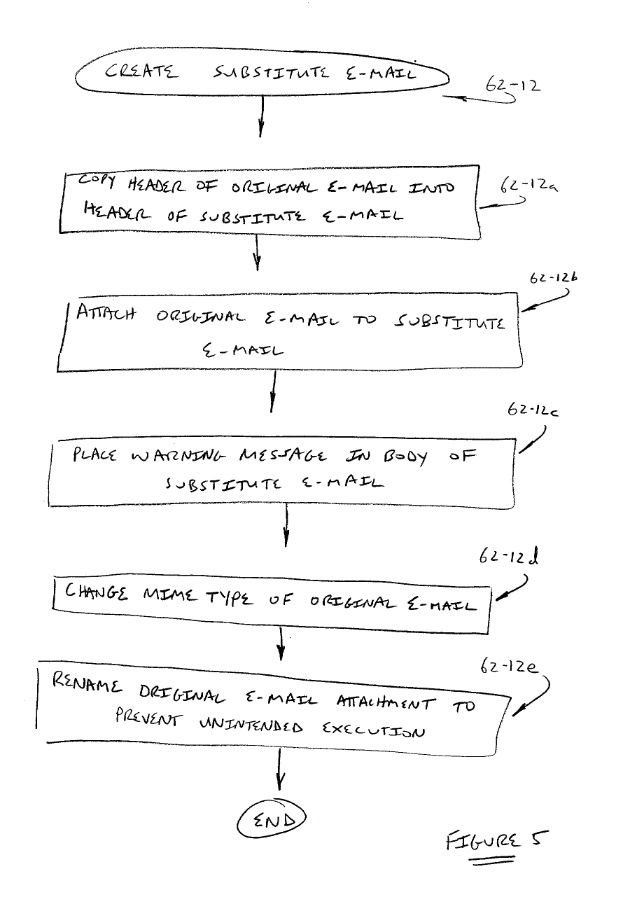

Referring now to FIG. 5, the step 62-12 by which the bridge 20 creates a substitute e-mail is fully explained. In a step 62-12a, the bridge 20 copies the header of the original e-mail and uses this copy as the header for the substitute e-mail being created. This preserves to “to” “from” “subject” and other header information. In a step 62-12b, the bridge 20 attaches the original e-mail to the substitute e-mail. In a step 62-12c, the bridge 20 inserts a warning message into the body of the substitute e-mail. For example, the warning message could read, “WARNING: Potentially Dangerous E-Mail—Please See Network Administrator for Assistance if you do not recognize the Sender.”

In a step 62-12d, the bridge 20 changes the MIME type of the original e-mail (now attached to the substitute e-mail) to a MIME type that is “safe”—i.e., a non-executable MIME type such as “text/plain” or the like. In a step 62-12e, the bridge 20 changes the name of the attachment to the original e-mail to prevent accidental or unwanted execution of the attachment. In one preferred embodiment, the step 62-12e preserves the original file name but appends one or more new extensions to the filename so that the file is rendered non-executable without a recipient first changing the name back to the original name or another executable name. For example, if the attachment was originally names “virus.exe” the step 62-12e would change the name to virus.exe.bad.bad. Adding two extensions “.bad.bad” ensures that even if the user's e-mail system hides the final extension, as is sometimes the case, the user will still see one of the appended file extensions.” In this example, the originally named attachment could be executed by a recipient simply by double-clicking on the attachment. On the other hand, simply double-clicking on the renamed attachment would not result in same being executed and further purposeful steps would be required by the user. This, combined with the warning message in the body prevents or minimizes unintended execution of malicious or potentially malicious attachments by end-users. The step 62-12e of changing the name of the attachment is also effective in preventing a program that is resident on the user's computer from automatically executing or launching the attachment. For example, certain virus attachments have been known to use filenames that result in the attachment being automatically executed by a Windows® media player or other similar program. The step 62-12e of renaming the attachment prevents this type of attack.

Thus, according to the foregoing method, the header of the substitute e-mail is a copy of the original e-mail header. The body of the substitute e-mail is a warning message. The substitute e-mail includes an attachment that comprises the original e-mail body and also the original e-mail attachment, except that the original e-mail (now attached to the substitute e-mail) has been altered to include a “safe” MIME type and the attachment to the original e-mail has been renamed to prevent unintended or automatic execution.

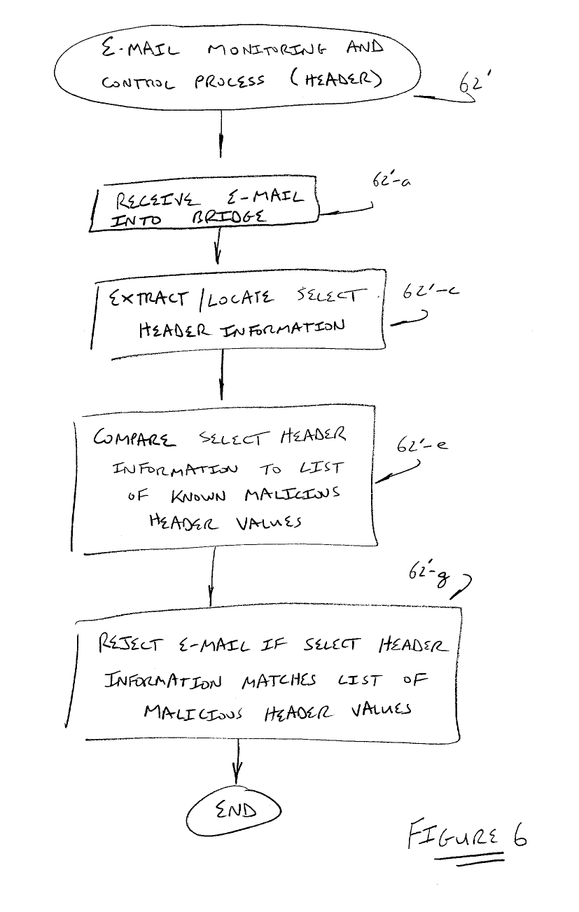

FIG. 6 illustrates another e-mail monitoring and control process 62′ performed by the bridge 20 in accordance with the present invention. The process 62′ includes a step 62′-a of receiving all incoming e-mail into the bridge 20. A step 62′-c includes extracting or locating select header information of the e-mail. The select header information can include, e.g., the sender, path, subject, etc. In a step 62′-e, the bridge 20 compares the select header information with a list of known header values that indicate a malicious or potentially malicious e-mail or simply undesirable e-mail such as e-mail originating from or that has been forwarded by a domain that indicates adult content. In a step 62′-g, the bridge 20 rejects the e-mail by deleting it or returning it to the sender. Alternatively, the bridge 20 can create a substitute e-mail as described above in step 62-12 and pass the substitute e-mail into the mail server of the user network 14. Here, again, those of ordinary skill in the art will recognize that all e-mail monitoring and control processes 62′ occur at the bridge 20 and not on a mail server or other computer that forms a part of the user network.

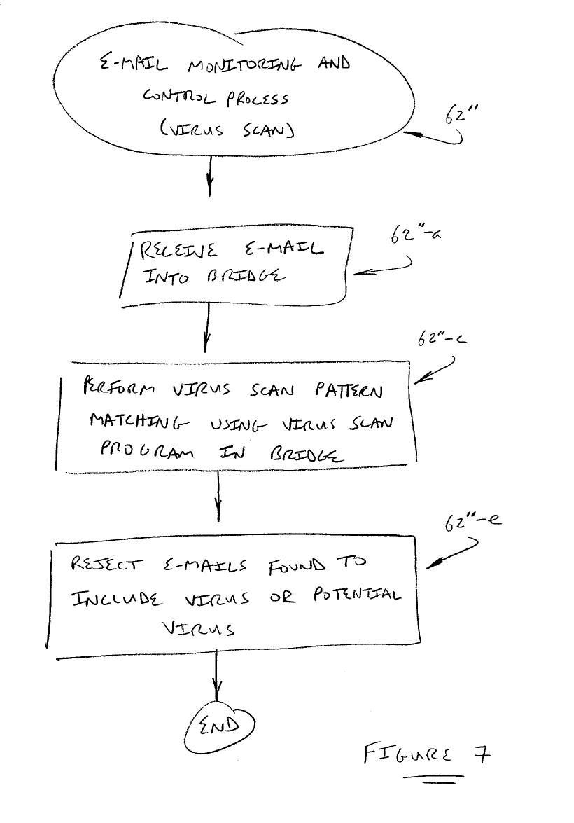

FIG. 7 illustrates a virus-scan e-mail process 62″ that can be implemented by the bridge 20 upstream from the user network 14. Here, the bridge receives all incoming e-mail in a step 62″-a. In a step 62″-c, the bridge 20 executes one or more virus scan programs to scan the incoming e-mail in an effort to identify any viruses within the e-mail using a pattern matching algorithm or the like. These virus scan programs can be any suitable virus scan programs available from third-party vendors, if desired. In a step 62″-e, the bridge 20 rejects any e-mail found to contain a virus or a suspected virus. Of course, instead of simply rejecting the e-mail, the bridge can be configured to generate a substitute e-mail according to the step 62-12 described above.

Modifications and alterations will occur to those of ordinary skill in the art upon reading the foregoing in connection with the accompanying drawings. It is intended that all such modifications and alterations be encompassed within the scope of the invention as defined by the following claims.

Having thus described the preferred embodiments, what is claimed is:

1. A method for enhancing network security comprising:
locating a bridge operatively between a public computer network and a private computer network;
receiving incoming network data traffic from said public computer network into said bridge prior to said incoming network data traffic being transmitted to said private computer network;
analyzing said incoming network data traffic in said bridge to determine if said incoming network data traffic includes potentially malicious network data traffic;
using a non-public communications channel to connect said bridge to a remote data center and sending data from said bridge to said remote data center that notifies said data center that potentially malicious incoming network data traffic has been received by said bridge when said bridge determines that said incoming network data traffic includes potentially malicious incoming network data traffic;
controlling said bridge from said data center through said non-public communications channel to respond to said potentially malicious network data traffic to limit passage of further potentially malicious incoming network data traffic to said private computer network.

2. The method as set forth in claim 1, further comprising:
notifying an administrator from said data center when said bridge reports the presence of potentially malicious network data traffic to said data center.

3. The method as set forth in claim 2, wherein said step of notifying an administrator comprises notifying an administrator by at least one of e-mail, paging and telephone.

4. The method as set forth in claim 1, further comprising:
receiving outgoing network data traffic from said private computer network into said bridge prior to said outgoing network data traffic being transmitted to said public computer network;
analyzing said outgoing network data traffic in said bridge to determine if said outgoing network data traffic includes potentially malicious network data traffic;
using a non-public communications channel to connect said bridge to a remote data center and sending data from said bridge to said remote data center that notifies said data center that potentially malicious network data traffic has been received by said bridge when said bridge determines that said outgoing network data traffic includes potentially malicious network data traffic;
controlling said bridge from said data center through said non-public communications channel to respond to said potentially malicious outgoing network data traffic to limit passage of further potentially malicious network data traffic to said public computer network.

5. The method as set forth in claim 4, wherein said steps of analyzing said incoming network data traffic and analyzing said outgoing network data traffic comprise:
analyzing said incoming and outgoing network data traffic to determine if said network data traffic relates to at least one of unauthorized access to the bridge from said public computer network, unauthorized access to the bridge from said private computer network, unauthorized access to said private computer network from said public computer network, a port scan performed on said bridge, execution of an attack script originating from said public computer network and targeting a computer on the private computer network, execution of an attack script originating on the private network and targeting a computer on said public computer network, an abnormal volume of network traffic originating on the public computer network and targeting the private computer network, an unreasonable volume of network traffic originating on the private computer network targeting a computer on the public computer network, detection of known attack signatures, detection of known malicious traffic based upon code and/or header information, detection of known or potentially malicious traffic based upon statistical analysis and research of traffic, detection of a user of the private computer network attempting to access an unauthorized website, detection of attempted tampering with the bridge.

6. The method as set forth in claim 1, wherein said non-public communications channel comprises a private dial-up telephone communications channel.

7. The method as set forth in claim 1, further comprising:
periodically connecting said bridge to said remote data center; and,
synchronizing files on said bridge and at said remote data center when said bridge periodically connects to said remote data center.

8. The method as set forth in claim 4, further comprising:
using said bridge to record address information that describes the source and destination of said incoming and outgoing network data traffic received into said bridge; and,
periodically sending said recorded address information from said bridge to said remote data center by said non-public communications channel.

9. The method as set forth in claim 1, wherein said incoming network data traffic comprises e-mail data representing an original e-mail message and wherein said method further comprises, within said bridge:
determining if said original e-mail includes a potentially dangerous attachment;
creating a safer substitute e-mail comprising a header and a body to replace said original e-mail when said original e-mail includes a potentially dangerous attachment; and,
sending said substitute e-mail to said private computer network in place of said original e-mail.

10. The method as set forth in claim 9, wherein said step of creating a safer substitute e-mail comprises, in said bridge:
copying header information of said original e-mail into said header of said substitute e-mail;
attaching the original e-mail to the body of the substitute e-mail;
inserting a warning message into the body of the substitute e-mail;
changing the MIME type of the original e-mail to a safe MIME type; and,
renaming the potentially dangerous attachment to the original e-mail with a new name that prevents unintended execution of the potentially dangerous attachment.

11. The method as set forth in claim 1, wherein said incoming network data traffic comprises e-mail data representing an original e-mail message and wherein said method further comprises, within said bridge:
extracting header information from said original e-mail message;
comparing said extracted header information to a list of known header information associated with potentially malicious e-mail messages; and,
using said bridge to prevent passage of said original e-mail to said private computer network when at least some of said extracted header is found on said list.

12. The method as set forth in claim 1, wherein said incoming network data traffic comprises e-mail data representing an original e-mail message and wherein said method further comprises, within said bridge:
performing a virus scan pattern matching operation on said original e-mail; and,
using said bridge to prevent passage of said original e-mail to said private computer network when said virus scan pattern matching step indicates a virus-that said original e-mail is infected with a virus.

13. A method for monitoring and controlling e-mail, said method comprising:
receiving an original e-mail message intended for a downstream recipient;
determining if said original e-mail includes a potentially dangerous attachment;
creating a safer substitute e-mail comprising a header and a body to replace said original e-mail when said original e-mail includes a potentially dangerous attachment; and,
sending said substitute e-mail to said intended downstream recipient in place of said original e-mail.

14. The method as set forth in claim 13, wherein said step of creating a safer substitute e-mail comprises:
copying header information of said original e-mail into said header of said substitute e-mail;
attaching the original e-mail to the body of the substitute e-mail;
inserting a warning message into the body of the substitute e-mail;
changing the MIME type of the original e-mail to a safe MIME type; and,
renaming the potentially dangerous attachment to the original e-mail with a new name that prevents unintended execution of the potentially dangerous attachment.
